(19) United States
(12) Patent Application Publication
(10) Pub. No.: US 2021/0359840 A1
(43) Pub. Date: Nov. 18, 2021

(54) MANAGEMENT SYSTEM FOR ASSET DYNAMIC VALUE BASED ON BLOCKCHAIN AND METHOD THEREOF

(71) Applicant: Skychain CO., LTD., Taipei (TW)

(72) Inventors: Chen-Hsuan WANG, Taipei (TW); Jiann-Min YANG, Taipei (TW); Scott MIAU, Taipei (TW)

(21) Appl. No.: 17/320,239

(22) Filed: May 14, 2021

(30) Foreign Application Priority Data
May 15, 2020 (TW) 109116145

(51) Int. Cl. H04L 9/06; H04L 9/32; G06F 9/46

(52) U.S. Cl. CPC H04L 9/0643; H04L 2209/38; G06F 9/466; H04L 9/3218

(57) ABSTRACT

A management system for asset dynamic value based on blockchain and a method thereof are disclosed. In the management system, an asset management host, an asset holding host and a transaction object host serving as nodes on a blockchain network are provided; the asset management host creates a smart contract associated with an asset to record statuses of funds, holdings and sub-assets; the asset holding host and the transaction object host are permitted to execute functions in the smart contract, so as to perform the transfer between the funds and the holdings and store the sub-assets in the smart contract. Therefore, the technical effect of improving convenience and credibility in dynamic management of asset value can be achieved.

### CROSS-REFERENCE TO RELATED APPLICATIONS

The present application is based on, and claims priority from, Taiwan Application Serial Number 109116145, filed May 15, 2020, the disclosure of which is hereby incorporated by reference herein in its entirety.

### BACKGROUND

### 1. Technical Field

The present invention relates to a management system and a method thereof, and more particularly to a management system for asset dynamic value based on blockchain and a method thereof.

### 2. Related Art

In recent years, with the popularity and vigorous development of blockchain technology, various applications based on blockchain spring up. The combination of the blockchain and asset management is one of the most popular applications.

Generally speaking, the conventional asset management is a financial service for asset and has a purpose of achieving investment goals for the interests of investors. Therefore, how to evaluate the value of assets immediately and appropriately is extremely critical, especially when there are various types of assets and not all types of assets can be immediately and appropriately quantified in value like securities. For example, in a condition that the asset is a construction project, the construction project can actually be divided into multiple project items such as hydropower works, cement works, and wood works, and the overall value of the construction project may be impacted by whether these project items are completed or delivered, or pass the acceptance. However, the conventional asset management method is unable to immediately and appropriately add the corresponding value to the asset after one of the project items is completed. There is a problem that the value of asset is difficult to dynamically manage.

Therefore, some manufacturers proposed a technical solution for automated revaluation of asset, and the technical solution is to quantify the value of asset through real-time evaluation of market price, cash flow, asset and liabilities. However, the evaluation basis of this solution may be challenged easily, for example, when the source of the data is unknown or untrusted, it leads to disputes and challenges for the quantized value of asset. The above-mentioned conventional solution is still unable to effectively solve the problem that the value of asset is difficult to dynamically manage.

According to above-mentioned contents, what is needed is to develop an improved technical solution to solve the problem that the value of the asset is difficult to dynamically manage.

### SUMMARY

An objective of the present invention is to disclose a management system for asset dynamic value based on blockchain and a method thereof, to solve the above-mentioned conventional technical problem.

In order to achieve the objective, the present invention provides a management system for asset dynamic value based on blockchain, and the management system is applied to a blockchain network formed by a plurality of node and includes an asset management host, an asset holding host and a transaction object host. The asset management host serves as one of the plurality of nodes of the blockchain network, and includes a creating module and an executing module. The creating module is configured to create an asset smart contract associated with an asset, and deploy the asset smart contract to the blockchain network. The asset smart contract includes an asset-holding management function set and a sub-asset management function set. The executing module is connected to the creating module and configured to execute the asset-holding management function set to set a transfer regulation between holdings and funds in the asset smart contract. The asset holding host serves as one of the plurality of nodes of the blockchain network, and is configured to execute the asset-holding management function set to input a fund associated with the asset into the asset smart contract, and then register at least one holding associated with the funds to be held by the asset holding host based on the transfer regulation. The transaction object host serves as one of the plurality of nodes of the blockchain network, and is configured to execute the sub-asset management function set to transfer a sub-asset held by the transaction object host to the asset smart contract.

In order to achieve the objective, the present invention provides a management method for asset dynamic value based on blockchain, and the management method is applied to a blockchain network formed by a plurality of nodes and includes steps of: providing an asset management host, an asset holding host and a transaction object host, wherein each of the asset management host, the asset holding host and the transaction object host serves as one of the plurality of nodes, respectively; using the asset management host to create an asset smart contract associated with an asset, and deploy the asset smart contract to the blockchain network, wherein the asset smart contract comprises an asset-holding management function set and a sub-asset management function set; using the asset holding host to execute the asset-holding management function set to set a transfer regulation between holdings and funds in the asset smart contract; using the asset holding host to execute the asset-holding management function set to input fund associated with the asset in the asset smart contract, and register at least one holdings associated with the funds to be held by the asset holding host, based on the transfer regulation; executing the sub-asset management function set in the asset management host and the transaction object host, to transfer the funds held in the asset smart contract to the transaction object host, and transfer a sub-asset of the transaction object host to the asset smart contract.

According to above-mentioned system and method of the present invention, the difference between the conventional technology and the present invention is that, in the management system of the present invention, the asset management host, the asset holding host and the transaction object host serving as nodes on the blockchain network are provided, the asset management host can create the smart contract associated with the asset to record statuses of funds, holdings and sub-assets, the asset holding host and the transaction object host are permitted to execute functions in the smart contract, so as to perform the transfer between the funds and the holdings and store the sub-assets in the smart contract.

By the above-mentioned technical solution of the present invention, the technical effect of improving convenience and credibility in dynamic management of asset value can be achieved.

### BRIEF DESCRIPTION OF THE DRAWINGS

The structure, operating principle and effects of the present invention will be described in detail by way of various embodiments which are illustrated in the accompanying drawings.

FIG. 1 is a system block diagram of a management system for asset dynamic value based on blockchain, according to the present invention.

FIGS. 2A to 2C are flowcharts of a management method for asset dynamic value based on blockchain, according to the present invention.

FIG. 3 is a schematic view of using a smart contract associated with an asset to manage funds and value of an asset, in application of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

Before description of a management system for asset dynamic value based on blockchain and a method thereof of the present invention, the terms defined in the present invention are explained in the following paragraphs. The term “sub-asset” described in the present invention refers to various items included in an asset, for example, stocks and bonds held by a funds belong to sub-assets; for example, for an asset being construction case, proofs of completion or delivery for various work items also belong to sub-assets. In fact, the sub-asset can be stored in the form of record (such as a hash value) or the form of token on the blockchain. The term “asset smart contract” refers to a smart contract associated with an asset (such as a construction project, a fund, a fundraising development product project or an artwork) and deployed on a blockchain network. In fact, the smart contract means a computer program for driving execution commands based on a predetermined condition and transferred information, and particularly, the smart contract is programmed with programming language, such as Solidity, Serpent, LLL, EtherScript, or Sidechain, and the smart contract can include different functions, events and parameter states; for example, in Ethereum environment, a smart contract is compiled to obtain binary codes and an application binary interface (ABI), so as to broadcast the smart contract to the blockchain network and wait for a miner or a validator to deploy the smart contract in the blockchain to obtain a corresponding address, which is also called a contract address; so far the smart contract is completely deployed through the blockchain transaction. Next, each node host can execute the smart contract based on the corresponding address, and change a state of the smart contract in the blockchain by different command and detect whether an event is triggered.

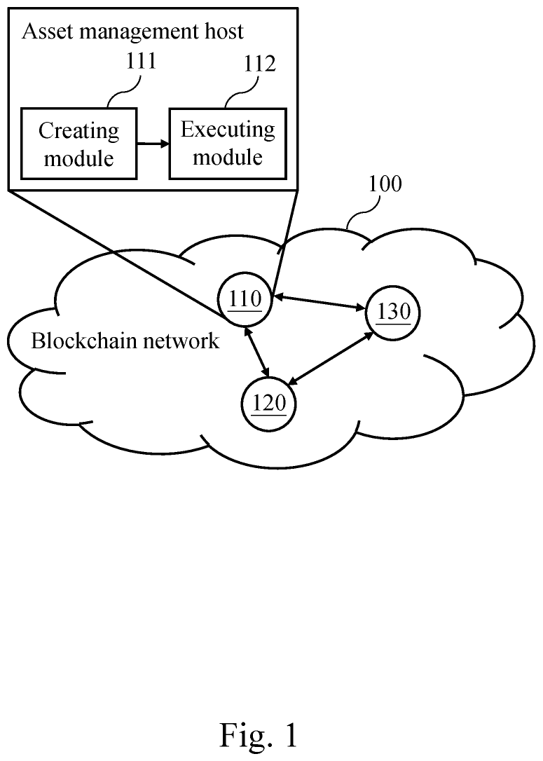

A management system for asset dynamic value based on blockchain and a method thereof of the present invention will hereinafter be described in more detail with reference to the accompanying drawings. Please refer to FIG. 1, which is a system block diagram of a management system for asset dynamic value based on blockchain, according to the present invention. As shown in FIG. 1, the management system is applied to a blockchain network 100 formed by a plurality of nodes, and the management system includes an asset management host 110, an asset holding host 120, and a transaction object host 130. The asset management host 110 serves as one of the nodes of the blockchain network 100, and the asset management host 110 includes a creating module 111 and an executing module 112. The creating module 111 is configured to create an asset smart contract associated with an asset, and deploy the asset smart contract to the blockchain network 100. The asset smart contract includes two function sets including an asset-holding management function set and a sub-asset management function set, and each of the asset-holding management function set and the sub-asset management function set is permitted to execute one or more than one function thereof individually. In actual implementation, the asset smart contract is deployed to the blockchain network 100 through a blockchain transaction. The executing module 112 is connected to the creating module 111 and configured to execute the asset-holding management function set to set a transfer regulation between holdings and funds in the asset smart contract, for example, the regulation about who can invest how much funds to get an equal amount of holdings or get holdings of an amount calculated in proportion; for example, in the condition of getting an equal amount of holdings, when a funder invests 100 million dollars, the funder obtains 100 million holdings; in the condition of getting holdings of an amount calculated in proportion, when a transfer ratio of holdings to funds defined in the transfer regulation is 1:5, it indicates that investment of five dollars can obtain one unit of holding, and when a funder B invests 50 million dollars, the funder B obtains 10 million units of holding. In actual implementation, the transfer regulation can include a transfer ratio, a permitted transferor, a transfer manner, a fund amount and a holding amount, and so on. The asset management host 110 can execute the asset-holding management function set to adjust the transfer regulation, for example, after the value of the asset increases, the transfer ratio of 1:5 can be adjusted to 1:6; or after the value of the asset decreases, the transfer ratio can be adjusted from 1:5 is adjusted to 1:1. Furthermore, the asset management host 110 can execute the sub-asset management function set to write the sub-asset into the asset smart contract, cancel sub-asset, or transfer the sub-asset to the transaction object host 130. In fact, the aforementioned operations of adjusting transfer regulation, writing sub-asset in asset smart contract, cancelling sub-asset or transferring sub-asset can be implemented by changing the status of parameter in the asset smart contract. The operation of transferring sub-asset is taken as an example, the transfer operation can be implemented by the form of token representing the sub-asset, or by writing a proof in the asset smart contract. The proof can be proof material which is able to increase the value of asset, for example, the proof can be a land transfer certificate, or project acceptance document. The proof can be stored in plain text, encoded form (such as coded by Base64), hashed form or encrypted form, or a combination of at least two of these three forms. The hash form can be calculated by using message-digest algorithm 5 (MD5), security hash algorithm 1 (SHA-1), SHA-256, or other similar hash function.

The asset holding host 120 serves as one of the node of the blockchain network 100, and configured to execute the asset-holding management function set to input a fund associated with the asset into the asset smart contract, and register the holdings associated with the fund to be held by the asset holding host 120 based on the transfer regulation. For example, in the above-mentioned case of the funder obtaining 100 million units of holding, the registration is to record an address of the asset holding host 120 and the amount of the holdings into an array of the asset smart contract as a record of the holdings. In actual implementation, the asset holding host 120 can execute the asset-holding management function set, to transfer or cancel self-owned holdings and retrieve corresponding amount of funds from the asset smart contract based on the transfer regulation. Furthermore, the operation of transferring or cancelling holdings can be implemented by changing the status of the parameter for storing the record of holdings in the asset smart contract.

The transaction object host 130 serves as one of the node of the blockchain network 100, and configured to execute the sub-asset management function set to transfer the sub-asset held by the transaction object host 130 to the asset smart contract. Besides, the transaction object host 130 also can execute the sub-asset management function set to transfer the fund held by the transaction object host 130 to the asset smart contract. Particularly, the transfer of the fund can be implemented by digital currency transfer.

It is to be particularly noted that, in actual implementation, the modules of the present invention can be implemented by various manners, including software, hardware or any combination thereof, for example, in an embodiment, the module can be implemented by software and hardware, or one of software and hardware. Furthermore, the present invention can be implemented fully or partly based on hardware, for example, one or more module of the system can be implemented by integrated circuit chip, system on chip (SOC), a complex programmable logic device (CPLD), or a field programmable gate array (FPGA). The concept of the present invention can be implemented by a system, a method and/or a computer program. The computer program can include computer-readable storage medium which records computer readable program instructions, and the processor can execute the computer readable program instructions to implement concepts of the present invention. The computer-readable storage medium can be a tangible apparatus for holding and storing the instructions executable of an instruction executing apparatus Computer-readable storage medium can be, but not limited to electronic storage apparatus, magnetic storage apparatus, optical storage apparatus, electromagnetic storage apparatus, semiconductor storage apparatus, or any appropriate combination thereof. More particularly, the computer-readable storage medium can include a hard disk, an RAM memory, a read-only-memory, a flash memory, an optical disk, a floppy disc or any appropriate combination thereof, but this exemplary list is not an exhaustive list. The computer-readable storage medium is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub and/or gateway. The network card or network interface of each calculating/processing apparatus can receive the computer readable program instructions from network, and forward the computer readable program instruction to store in computer-readable storage medium of each calculating/processing apparatus. The computer program instructions for executing the operation of the present invention can include source code or object code programmed by assembly language instructions, instruction-set-structure instructions, machine instructions, machine-related instructions, micro instructions, firmware instructions or any combination of one or more programming language. The programming language include object oriented programming language, such as Common Lisp, Python, C++, Objective-C, Smalltalk, Delphi, Java, Swift, C#, Perl, Ruby, and PHP, or regular procedural programming language such as C language or similar programming language. The computer readable program instruction can be fully or partially executed in a computer, or executed as independent software, or partially executed in the client-end computer and partially executed in a remote computer, or fully executed in a remote computer or a server.

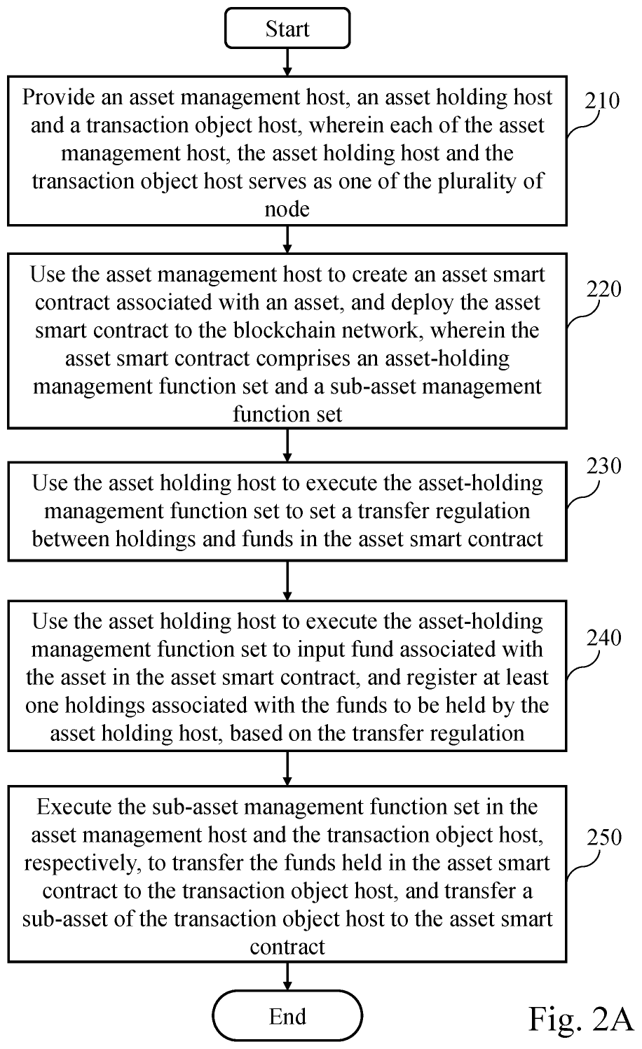

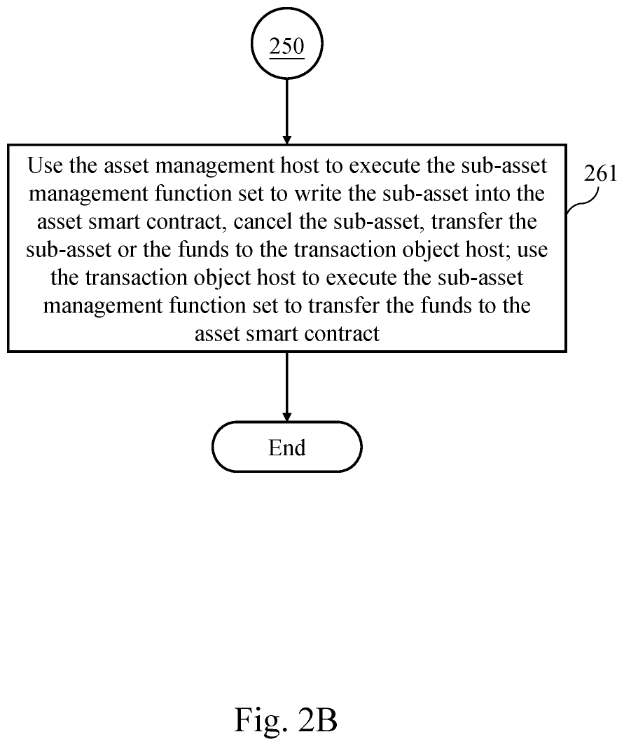

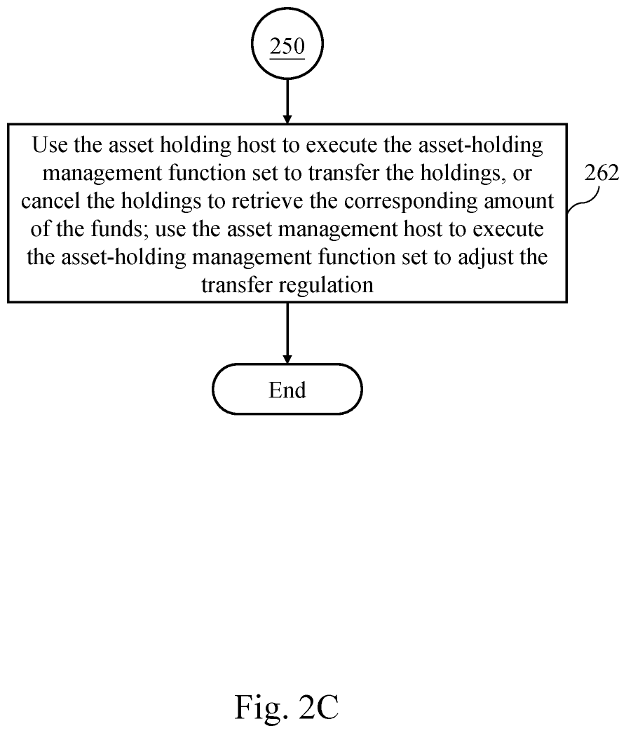

Please refer to FIGS. 2A to 2C, which are flowcharts of the management method for asset dynamic value based on blockchain, according to the present invention. The management method can be applied to a blockchain network 100 formed by nodes, and the management method includes following steps. In a step 210, an asset management host 110, an asset holding host 120 and a transaction object host 130 are provided, and each of the asset management host 110, the asset holding host 120 and the transaction object host 130 serves as one of the nodes. In a step 220, the asset management host 110 creates an asset smart contract associated with an asset, and deploys the asset smart contract to the blockchain network 100, and the asset smart contract includes an asset-holding management function set and a sub-asset management function set. In a step 230, the asset management host 110 executes the asset-holding management function set, to set a transfer regulation between holdings and funds in the asset smart contract. In a step 240, the asset holding host 120 executes the asset-holding management function set, to input a fund associated with the asset in the asset smart contract, and register the holding, corresponding to the input fund, to be held by the asset holding host 120 based on the transfer regulation. In a step 250, the asset management host 110 and the transaction object host 130 execute the sub-asset management function set, to transfer the fund held in the asset smart contract to the transaction object host 130, and transfer a sub-asset of the transaction object host 130 to the asset smart contract. Through aforementioned steps, the asset management host 110, the asset holding host 120 and the transaction object host 130 serving as nodes are provided in the blockchain network 100; the asset management host 110 creates the smart contract associated with the asset to record statuses of funds, holdings and sub-assets, and the asset holding host 120 and the transaction object host 130 are permitted to execute the functions in the smart contract, so as to perform the transfer between the funds and the holdings and store the sub-asset in the smart contract.

Furthermore, as shown in FIG. 2B, a step 261 can be executed after the step 250. In the step 261, the asset management host 110 can execute the sub-asset management function set to write sub-asset into in the asset smart contract, cancel sub-asset, or transfer sub-asset or funds to the transaction object host 130, and the transaction object host 130 can execute the sub-asset management function set to transfer the funds to the asset smart contract. One or more than one of functions of the sub-asset management function set is permitted to individually execute at the same time. Besides, as shown in FIG. 2C, a step 262 can be executed after the step 250. In the step 262, the asset holding host 120 can execute the asset-holding management function set to transfer or cancel holdings to retrieve corresponding amount of fund from the asset smart contract, and the asset management host 110 can execute the asset-holding management function set to adjust the transfer regulation. One or more than one of functions of the asset-holding management function set is permitted to individually execute at the same time; for example, the asset management host 110 can execute the asset-holding management function set to adjust the transfer ratio in the transfer regulation based on the amount or value of the sub-asset.

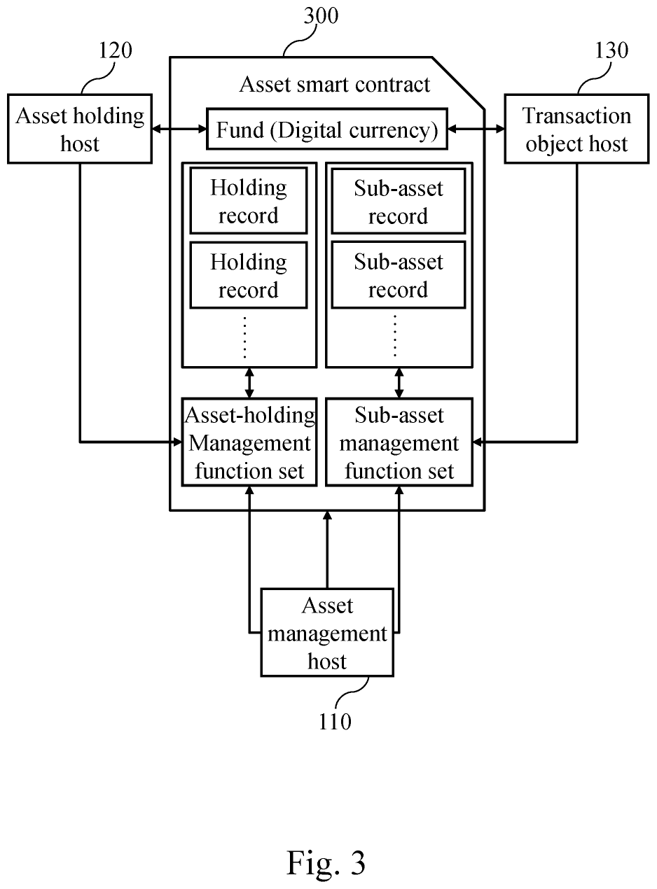

The embodiment of the present invention is described with reference to FIG. 3 in the following paragraphs. As shown in FIG. 3, which is a schematic view of using a smart contract associated with an asset to manage funds and value of the asset, in application of the present invention. In an embodiment, the asset can be a construction project, the asset management host 110 can represent a construction company, the asset holding host 120 can represent a development project funder, the sub-asset can be content of the construction project, and the transaction object host 130 can represent a construction contractor and a house buyer. The manner of transferring the sub-asset into or from a smart contract is performed by storing proof, for example, the proof to be stored can be a proof of completion or a proof of building handover. The overall process includes the following steps.

In a first step, the construction company creates a construction contract (that is, the asset smart contract 300) through the asset management host 110, and the construction contract includes an asset-holding management function set and a sub-asset management function set.

In a second step, the construction company executes the asset-holding management function set through the asset management host 110, to set a transfer regulation between holdings and funds, for example, the regulation about who can invest how much funds to obtain equal amount of holdings or a proportional amount of holdings.

In a third step, the development project funder executes the asset-holding management function set through the asset holding host 120, to invest funds into the construction contract, so as to obtain the corresponding amount of building holdings based on the transfer regulation; for example, when a funder A invests 100 million dollars, the funder A obtains 100 million holdings; when an investor B invests 50 million dollars, the funder B obtains 50 million holdings. In actual implementation, the asset-holding management function set writes the obtained holdings of the building into the asset smart contract 300 as a record of the holdings, and the record of the holdings at least includes the address of the asset holding host 120 and the obtained amount of the holdings.

In a fourth step, the construction company executes the sub-asset management function set, through the asset management host 110, to transfer fund (that is, the invested fund) held by the construction contract to the transaction object host 130 which represents the construction contractor; for example, when the construction company pays 30 million dollars to a specific project item (such as steel frame contractor, grouting contractor and other construction contractor) from the construction contract.

In a fifth step, the construction contractor executes the sub-asset management function set through the transaction object host 130, to write the sub-asset (such as a proof of completion or delivery) into the construction contract as the record of the sub-asset, so as to prove that the construction contractor obtains the sub-asset. In actual implementation, the fourth step and fifth step can be bound to execute, so that the construction contractor can obtain the sub-asset while transferring the fund; for example, the proof of completion signed by the construction company can be stored in the construction contract. It is to be particularly noted that the land seller can write a land holding certificate into the construction contract, to prove that the sub-asset (that is, land) is obtained.

In a sixth step, the construction company executes the sub-asset management function set through the asset management host 110, to write proof of delivery into the construction contract, so as to prove that the sub-asset (that is, the output object of project) held by the construction contract is transferred to the house buyer, for example, the ownership certificate can be transferred to and stored in the construction contract.

In a seventh step, the house buyer executes the sub-asset management function set through the transaction object host 130, to transfer the fund to the construction contract, for example, the house buyer pays 10 million dollars to obtain one house in the construction project. In actual implementation, the sixth step and the seventh step can be bound in execution, so that the construction contract obtains the fund while the sub-asset is transferred from the asset (such as the construction project).

In an eighth step, the development project funder executes the asset-holding management function set through the asset holding host 120, to transfer the self-owned holding to other person; for example, the development project funder performs profit-sharing holding transfer, gift or transaction.

In a ninth step, the development project funder executes the asset-holding management function set through the asset holding host 120, to cancel holding to retrieve the corresponding fund based on the transfer regulation; that is, the development project funder performs redemption. For example, when the development project is sold out, the development project funder can retrieve the corresponding fund based on a holding proportion. For example, in the above-mentioned example, the funder A can obtain the fund corresponding to 100 million holdings.

In a tenth step, the construction company executes the asset-holding management function set through the asset management host 110 to adjust the transfer regulation, for example, to set who is permitted to invest how much fun to obtain the equal amount or proportional amount of holdings or set who is permitted to ransom how much holdings. In actual implementation, the corresponding relationship between the total current value of the project and the holdings can be adjusted according to the sub-asset held in the construction project, for example, in initial, the invested fund is 150 million dollars and amount of the total holdings is 150 million holdings, and after various sub-asset transactions, the total funds of the asset become 200 million dollars, and in this case, the 150 million holdings should be correspondingly adjusted to 200 million dollars for redemption.

It is to further explain that when the development funder is also the house buyer, that is, the development funder pre-pay for the house, the sub-asset can be transferred and the holdings is cancelled at the same time, so as to complete the object right delivery. Furthermore, the fourth to tenth steps are not limited to execute in a fixed sequence, and each of the fourth to tenth steps may be repeated for many times, so as to dynamically manage the total value of the construction project.

In an embodiment, the asset is a funds, the asset management host 110 can represent a fund manager, the asset holding host 120 can represent a fund investor, the sub-asset is stock held by the funds, the transaction object host 130 can represent the person trading stock. In a condition that the stock is issued in security token offering (STO), the sub-asset can be inputted and outputted by token. The steps of overall process are described in the following paragraphs.

In a first step, the fund manager creates a fund contract (that is, the asset smart contract 300) through the asset management host 110, and the fund contract includes the asset-holding management function set and the sub-asset management function set.

In a second step, the fund manager executes the asset-holding management function set through the asset management host 110, to set the transfer regulation between holdings and funds, for example, to set who is permitted to invest how much funds to obtain the equal amount or proportional amount of holdings, and set who is permitted to ransom how much funds to obtain the equal amount or proportional amount of funds.

In a third step, the fund investor executes the asset-holding management function set through the asset holding host 120, to invest the fund into the fund contract to obtain the corresponding amount of fund holdings, based on the transfer regulation; for example, when a funder A invests 100 million dollars, the funder A obtains 100 million holdings; when an investor B invests 50 million dollars, the funder B obtains 50 million holdings. In actual implementation, the asset-holding management function set writes the obtained fund holdings into the asset smart contract 300 as the record of the holdings, and the record of the holding at least includes an address of the asset holding host 120 and the obtained amount of the holdings.

In a fourth step, the fund manager executes the sub-asset management function set through the asset management host 110, to transfer the fund held by the fund contract into the transaction object host 130 which represents the stock trading object; for example, the fund manager pays 30 million dollars to the specific stock seller from the fund contract.

In a fifth step, the stock trading object executes the sub-asset management function set through the transaction object host 130, to transfer the sub-asset (such as, the stocks in the form of tokens) to the fund contract. In actual implementation, the fourth step and fifth step can be bound in execution, so that the construction contractor obtains the sub-asset (that is, stocks) while the fund is transferred.

In a sixth step, the fund manager executes the sub-asset management function set through the asset management host 110, to transfer the stocks in the form of tokens, to the stock trading object; for example, the manager transfers 1000 shares to the specific stock buyer.

In a seventh step, the stock trading object executes the sub-asset management function set through the transaction object host 130, to transfer the fund to the fund contract; for example, the stock buyer pays 15 million dollars to the fund contract. In actual implementation, the sixth step and the seventh step can be bound in execution, so that the fun is obtained while the sub-asset (stock) is transferred from the asset (fund).

In an eighth step, the fund investor executes the asset-holding management function set through the asset holding host 120, to transfer the self-owned holding to other person, for example, the fund investor performs transfer, gift or transaction of the fund holdings.

In a ninth step, the fund investor executes the asset-holding management function set through the asset holding host 120, to cancel holdings (such as for redemption) to retrieve the corresponding funds, based on the transfer regulation; for example, the fund investor performs redemption of fund holdings.

In a tenth step, the fund manager executes the asset-holding management function set to adjust the transfer regulation through the asset management host 110, for example, to set who is permitted to invest/ransom how much funds to obtain the equal amount or proportional amount of holdings/funds. For example, the total current value of the funds and the holding proportion of the new invested fund can be adjusted based on the value of stocks held by the funds. In a condition that the holding proportion is 1:1, when the value of the stocks held by the funds is more than the initial value, the fund required for obtaining one unit of holding exceeds one unit of fund, the manager of the fund can perform associated adjustment on the holding proportion, similarly, one unit of holding ransom more than one unit of fund. In the other hand, in a condition that the value of the stocks held by the funds is less than the initial value, the fund required for obtaining one unit of the holding is less than one unit of the fund, and similarly, one unit of holding ransoms less than one unit of fund.

In an embodiment, the asset can be a fundraising development product project, such as a product project on a fundraising platform, and the asset management host 110 can represent a fundraising R&D company, the asset holding host 120 can represent a fundraiser, the sub-asset can be R&D result and product, the transaction object host 130 can represent a R&D content provider (such as patent licensor or patent licensing company), a vender or a product buyer. The manner of inputting or outputting the sub-asset can be performed by the proof or the token, such as license proof, vender document proof, or the token representing commodity exchange voucher. The steps of overall process are described in the following paragraphs.

In a first step, the fundraising R&D company creates a fundraising R&D project contract (that is, the asset smart contract 300) through the asset management host 110, and the fundraising R&D project contract includes the asset-holding management function set and the sub-asset management function set.

In a second step, the fundraising R&D company executes the asset-holding management function set through the asset management host 110, to set the transfer regulation between holdings and funds, for example, to set who is permitted to invest how much funds to obtain equal amount or proportional amount of the holdings.

In a third step, the fundraiser executes the asset-holding management function set through the asset holding host 120, to invest fund to the fundraising R&D project contract, so as to obtain corresponding amount of the holdings of the R&D fundraising project based on the transfer regulation; for example, when a funder A invests three thousand dollars, the funder A obtains three thousand holdings, and when an investor B invests one thousand dollars, the investor B obtains one thousand holdings. In actual implementation, the asset-holding management function set writes the obtained holdings of the fundraising R&D project into the asset smart contract 300 as the record of the holdings, and the record of the holding at least includes the address of the asset holding host 120 and the obtained amount of holdings.

In a fourth step, the fundraising R&D company executes the sub-asset management function set through the asset management host 110, to transfer the fund held by the fundraising R&D project contract to the transaction object host 130 which represents the trading target (such as licensing company or vender); for example, the fundraising R&D company pays one million dollars to the specific patent licensing company from the fundraising R&D project contract.

In a fifth step, the licensing company or vender executes the sub-asset management function set through the transaction object host 130, to write the sub-asset (such as proof of completion, proof of delivery, or patent license document) into the fundraising R&D project contract as the record of the sub-asset, so as to prove the sub-asset is obtained, for example, a specific patent licensing company stores patent licensing document into the fundraising R&D project contract. In actual implementation, the fourth step and fifth step can be bound in execution, so that the sub-asset (that is, licensing, service or raw material) is obtained while the fund is transferred from the asset (that is, the fundraising R&D project).

In a sixth step, the fundraising R&D company executes the sub-asset management function set through the asset management host 110, to write a product delivery proof into the fundraising R&D project contract, so as to prove that the sub-asset (such as R&D result and product) held by the fundraising R&D project contract is transferred to the product buyer; for example, the fundraising R&D company delivers the token of the product to the product buyer from the fundraising R&D project contract.

In a seventh step, the product buyer executes the sub-asset management function set, through the transaction object host 130, to transfer the fund to the fundraising R&D project contract, for example, the product buyer pays one thousand dollars to the fundraising R&D project contract, to obtain the token of the product. In actual implementation, the sixth step and the seventh step can be bound in execution, so that the sub-asset (that is, the product) is transferred while fund is obtained from the asset (that is, the fundraising R&D project).

In an eighth step, the fundraiser executes the asset-holding management function set through the asset holding host 120, to transfer the self-owned holdings to other person, for example, the fundraiser performs profit-sharing holding transfer, gift or transaction.

In a ninth step, the fundraiser executes the asset-holding management function set through the asset holding host 120, to cancel the holdings for redemption, so as to retrieve the corresponding fund based on the transfer regulation; for example, the funder A can cancel the held 3000 holdings to ransom the fund corresponding to the 3000 holdings, and the amount of the ransomed fund may be changed according to different total price of the fundraising project.

In a tenth step, the fundraising R&D company executes the asset-holding management function set to adjust transfer regulation through the asset management host 110, for example, to set who is permitted to invest/ransom how much funds to obtain the equal amount or proportional amount of holdings/funds. For example, the corresponding relationship between the total current value of the R&D project and the holding can be adjusted according to the sub-asset (such as the amount or price of the completed products) held by the R&D project. For example, when the total value of the R&D project increase or decrease because of selling products, the fun required for investing/ransoming one unit of holding also increases or decreases.

It is to be particularly noted that, when the funder of the fundraising project is also the product buyer, that is, funder pre-pays for the product, the sub-asset can be transferred and the holdings is cancelled at the same time, so as to satisfy the object right delivery condition; for example, the funder A who invests 3000 dollars can obtain three tokens of products, and the funder B who invests 1000 dollars can obtain one token of product.

In actual implementation, the corresponding relationship between the total current value of the project and the holdings can be adjusted based on the sub-asset held in the construction project, for example, the invested fund is 150 million dollars and the total amount of holdings is 150 million units in initial, and various sub-asset transactions make the total funds of the asset become 200 million dollars, and in this case, the 150 million holdings should be adjusted to correspond to 200 million dollars for redemption.

In an embodiment, the asset is co-creation artwork, the asset management host 110 can represent a co-creation execution/promotion unit, the asset holding host 120 can represent an artwork creation investor/sponsor, the sub-asset can be creation content or result, the transaction object host 130 can represent a creation content provider (such as an artist participating the creation), a vender or an artwork buyer. The manner of transferring the sub-asset can be performed by proof, for example, by storing the creation content proof, artwork handling document, material acquisition proof in the contract. The steps of overall process are described in the paragraphs.

In a first step, the co-creation execution/promotion unit creates a co-creation artwork contract (the asset smart contract 300) through the asset management host 110, and the co-creation artwork contract includes the asset-holding management function set and the sub-asset management function set.

In a second step, the co-creation execution/promotion unit executes the asset-holding management function set through the asset management host 110, to set the transfer regulation between the holdings and the funds, for example, to set who is permitted to invest how much funds to obtain an equal amount or proportional amount of holdings.

In a third step, the artwork creation investor/sponsor executes the asset-holding management function set through the asset holding host 120, to invest fund to the co-creation artwork contract to obtain the corresponding amount of co-creation artwork holdings based on the transfer regulation; for example, a funder A invests 2 million dollars to obtain 2 million holdings, and an investor B invests 1 million dollars to obtain 1 million holdings. In actual implementation, the asset-holding management function set writes the obtained holding of co-creation artwork into the asset smart contract 300 as the record of the holdings. The record of the holdings at least includes the address of the asset holding host 120 and the obtained amount of the holdings.

In a fourth step, the co-creation execution/promotion unit executes the sub-asset management function set through the asset management host 110, to transfer the fund held by the co-creation artwork contract to the transaction object host 130 which represents the transaction target such as a co-creation artist or a vender; for example, the co-creation execution/promotion unit pays one million dollars to a co-creation artist (such as the creator of one sculpture in the entire group of sculptures) from the co-creation artwork contract.

In a fifth step, the co-creation artists or vender executes sub-asset management function set through the transaction object host 130, to write the proof of completion or delivery of the creation content into the co-creation artwork contract as the record of sub-asset, so as to prove that the sub-asset is obtained; for example, the co-creation artist transfers the proof of the ownership of the completed artwork to the co-creation artwork contract. In actual implementation, the fourth step and fifth step can be bound in execution, so that the fund is transferred from the asset (co-creation artwork) and the sub-asset (such as creation content, result or raw material) is obtained.

In a sixth step, the co-creation execution/promotion unit executes the sub-asset management function set through the asset management host 110, to write the proof of artwork delivery into the creation artwork contract, so as to prove that the sub-asset (such as creation result and artwork) held by the co-creation artwork contract is transferred to the artwork buyer; for example, the proof of auction transaction and ownership transfer of the entire group of sculptures is stored in the co-creation artwork contract.

In a seventh step, the artwork buyer executes the sub-asset management function set, through the transaction object host 130, to transfer fund to the creation artwork contract, for example, when the artwork buyer spends 5 million dollars to buy the artwork, the artwork buyer can pay digital currency equivalent to 5 million dollars to the co-creation artwork contract. In actual implementation, the sixth step and the seventh step can be bound in execution, so that the sub-asset (artwork) is transferred from the co-creation artwork contract which represents the asset, and the fund is obtained.

In an eighth step, the artwork creation investor/sponsor can execute the asset-holding management function set through the asset holding host 120, to transfer the self-owned holdings to other person, for example, the artwork creation investor/sponsor performs profit-sharing holding transfer, gift or transaction.

In a ninth step, the artwork creation investor/sponsor can execute the asset-holding management function set through the asset holding host 120, to cancel holdings to retrieve the corresponding fund (for redemption), based on the transfer regulation. The total value of the co-creation artwork contract may increase or decrease according to the auction price of the artwork, and the investing/ransoming fund corresponding to one unit of holding increase or decrease correspondingly.

In a tenth step, the co-creation execution/promotion unit executes the asset-holding management function set to adjust the transfer regulation through the asset management host 110, for example, to set who is permitted to invest how much funds or ransom how much holdings to obtain the equal amount or proportional amount of holdings/funds. For example, the corresponding relationship between the total value of the co-creation artwork and the holdings can be adjusted according to the sub-asset (such as the auction price of the completed artwork) held by the co-creation artwork contract.

It is to be particularly noted that, when the artwork creation investor/sponsor is also the artwork buyer, that is, the investor/sponsor pre-pays for the artwork, the transfer of the sub-asset and cancellation of the holdings can be executed at the same time, so s to satisfy the object right delivery condition. For example, when the funder C is fully funded in the beginning, the funder C can cancel the holdings to obtain all of completed artworks.

According to above-mentioned contents, the difference between the present invention and the conventional technology is that, in the management system of the present invention, the asset management host, the asset holding host and the transaction object host serving as nodes on the blockchain network are provided, the asset management host can create the smart contract associated with the asset to record statuses of funds, holdings and sub-assets, the asset holding host and the transaction object host are permitted to execute functions in the smart contract, so as to perform the transfer between the funds and the holdings and store the sub-assets in the smart contract. By the above-mentioned technical solution of the present invention, the technical effect of improving convenience and credibility in dynamic management of asset value can be achieved.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A management system for asset dynamic value based on blockchain, wherein the management system is applied to a blockchain network formed by a plurality of nodes, and comprises:
an asset management host serving as one of the plurality of nodes of the blockchain network, wherein the asset management host comprises:
a creating module configured to create an asset smart contract associated with an asset, and deploy the asset smart contract to the blockchain network, wherein the asset smart contract comprises an asset-holding management function set and a sub-asset management function set; and
an executing module connected to the creating module and configured to execute the asset-holding management function set to set a transfer regulation between holdings and funds in the asset smart contract;
an asset holding host serving as one of the plurality of nodes of the blockchain network, and configured to execute the asset-holding management function set to input a fund associated with the asset in the asset smart contract, and then register at least one holding associated with the funds to be held by the asset holding host, based on the transfer regulation; and
a transaction object host serving as one of the plurality of nodes of the blockchain network, and configured to execute the sub-asset management function set to transfer a sub-asset held by the transaction object host to the asset smart contract.

2. The management system for asset dynamic value based on blockchain according to claim 1, wherein the transfer regulation comprises a transfer ratio, a permitted transfer, a transfer manner, a fund amount, and a holding amount.

3. The management system for asset dynamic value based on blockchain according to claim 1, wherein the sub-asset is transferred by the form of token, or by writing a proof into the asset smart contract, and the proof is stored in a form of plain text, coded proof, hashed proof, encrypted proof, or a combination thereof.

4. The management system for asset dynamic value based on blockchain according to claim 1, wherein the asset management host is permitted to execute the sub-asset management function set to write the sub-asset into the asset smart contract, cancel the sub-asset, transfer the sub-asset or the funds to the transaction object host, and the transaction object host is permitted to execute the sub-asset management function set to transfer the funds to the asset smart contract, one or more than one of the functions of the sub-asset management function set is permitted to individually execute.

5. The management system for asset dynamic value based on blockchain according to claim 1, wherein the asset holding host is permitted to execute the asset-holding management function set to transfer the holdings, or cancel the holdings to retrieve the corresponding amount of the funds, the asset management host is permitted to execute the asset-holding management function set to adjust the transfer regulation, and one or more than one of functions of the asset-holding management function set is permitted to individually execute at the same time.

6. A management method for asset dynamic value based on blockchain, wherein the management method is applied to a blockchain network formed by a plurality of nodes, and comprises:
providing an asset management host, an asset holding host and a transaction object host, wherein each of the asset management host, the asset holding host and the transaction object host serves as one of the plurality of nodes;
using the asset management host to create an asset smart contract associated with an asset, and deploy the asset smart contract to the blockchain network, wherein the asset smart contract comprises an asset-holding management function set and a sub-asset management function set;
using the asset holding host to execute the asset-holding management function set to set a transfer regulation between holdings and funds in the asset smart contract;
using the asset holding host to execute the asset-holding management function set to input fund associated with the asset in the asset smart contract, and register at least one holdings associated with the funds to be held by the asset holding host, based on the transfer regulation; and
executing the sub-asset management function set in the asset management host and the transaction object host, to transfer the funds held in the asset smart contract to the transaction object host, and transfer a sub-asset of the transaction object host to the asset smart contract.

7. The management method for asset dynamic value based on blockchain according to claim 6, wherein the transfer regulation comprises a transfer ratio, a permitted transfer, a transfer manner, a fund amount, and a holding amount.

8. The management method for asset dynamic value based on blockchain according to claim 6, wherein the sub-asset is transferred by the form of token, or by writing a proof into the asset smart contract, and the proof is stored in a form of plain text, coded proof, hashed proof, encrypted proof, or a combination thereof.

9. The management method for asset dynamic value based on blockchain according to claim 6, wherein further comprising:
using the asset management host to execute the sub-asset management function set to write the sub-asset into the asset smart contract, cancel the sub-asset, transfer the sub-asset or the funds to the transaction object host; and
using the transaction object host to execute the sub-asset management function set to transfer the funds to the asset smart contract;
wherein one or more than one of the functions of the sub-asset management function set is permitted to individually execute.

10. The management method for asset dynamic value based on blockchain according to claim 6, wherein further comprising:
using the asset holding host to execute the asset-holding management function set to transfer the holdings, or cancel the holdings to retrieve the corresponding amount of the funds; and
using the asset management host to execute the asset-holding management function set to adjust the transfer regulation;
wherein one or more than one of functions of the asset-holding management function set is permitted to individually execute at the same time.
